(19) United States
(12) Patent Application Publication
(10) Pub. No.: US 2014/0250440 A1
(43) Pub. Date: Sep. 4, 2014

(54) SYSTEM AND METHOD FOR MANAGING STORAGE INPUT/OUTPUT FOR A COMPUTE ENVIRONMENT

(71) Applicant: Adaptive Computing Enterprises, Inc., Provo, UT (US)

(72) Inventors: Mason Lee CARTER, Ardley (GB); Colin WHITBREAD, Ascot (GB); Wil WELLINGTON, Ascot (GB)

(73) Assignee: Adaptive Computing Enterprises, Inc., Provo, UT (US)

(21) Appl. No.: 13/949,916

(22) Filed: Jul. 24, 2013

Related U.S. Application Data
(60) Provisional application No. 61/771,192, filed on Mar. 1, 2013.

(51) Int. Cl. G06F 9/50

(52) U.S. Cl. CPC G06F 9/505
USPC 718/105

(57) ABSTRACT

Disclosed herein are systems, methods, and computer-readable storage media for managing storage data input/output in a compute environment. The system receives data associated with workload or jobs that is to be processed in a compute environment. The system receives more data associated with a job that is to be scheduled to consume compute resources in the compute environment. Based on all the received data, the system transmits a signal to a storage input/output manager. The signal instructs the storage/output manager regarding how to manage a file transfer between the compute environment and a storage environment. The file transfer is associated with processing the job in the compute environment.

### PRIORITY CLAIM

This application claims priority to U.S. Provisional Patent Application 61/771,192, filed 1 Mar. 2013, the contents of which are herein incorporated by reference in their entirety.

### BACKGROUND

1. Technical Field

The present disclosure relates to a resource management system and more specifically to managing data transfers to and from a compute environment.

2. Introduction

Data storage has long been considered the weak link in high-performance computing and other large-scale compute environments. Especially, secondary storage devices—those non-volatile storage media that a CPU cannot directly access, such as hard disk drives—are typically slower by several orders of magnitude than other components in a computer, namely the CPU, the cache memory, the random access memory, and the system bus. Since the primary task of these data storage devices is to retain information on a long-term basis, if not permanently, they often rely on methods of reading and writing data that are very slow like magnetic recording or optical recording. Even with the advent of the solid-state memory technology, which has provided the much-needed boost in data access speed, the non-volatile data storage devices are still playing catch-up with the other components in the data input/output chain and remain a significant bottleneck.

In high-performance computing and enterprise-class computing, where speed is the name of the game, it is crucial to minimize the negative impact that the relatively sluggish data storage devices might have on the overall performance of the system. Traditionally in these classifications of compute environments, controlling the data storage devices has been either within the domain of the individual nodes that belong to the computing grid, cluster or enterprise data center, where each compute node has its own disks or in the domain of a network file system in which the individual disks are controlled by the network file system controller(s) and the individual nodes request data via file I/O from the network file system. A workload manager, which makes intelligent decisions about deploying computing jobs to various compute resources within the compute environment, had little or no control over the utilization of the individual data storage devices in the context of the network file system.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for managing file input/output for data storage in a compute environment. The approaches set forth herein can be used to control the file transfers to and from the data storage environment to decrease down time, prioritize tasks, and dynamically allocate resources. In one embodiment, a workload manager receives data associated with a job (or workload or process) that is to be processed in a compute environment. Next, the workload manager receives data associated with a job that is to be scheduled to consume compute resources in the compute environment. Then, the workload manager transmits a signal to a storage input/output manager. The signal is based on the data that were received by the workload manager regarding the job. To complete the job, a series of file transfers must occur between the compute environment and a storage environment. The storage environment can be a separate entity from the compute environment. Alternatively, the storage environment can be part of the compute environment. The signal sent by the workload manager instructs the storage input/output manager how to manage file transfers for the job between the compute environment and the storage environment.

For example, if a job with a certain service-level agreement (SLA) is submitted into the compute environment as managed by the workload manager, the workload manager may transmit to a storage input/output manager a signal, which causes the storage input/output manager to throttle up or down a file I/O transfer from a hard disk drive in a storage environment. Such an instruction would change the general algorithm the storage input/output manager would use for file I/O in order to speed up or down the file I/O for a particular job in order to meet the SLA requirements. Furthermore, given that the workload manager instructs the storage input/output manager, the storage input/output manager could also provide data regarding file I/O processes to the workload manager to help it make its instructions more intelligent.

### BRIEF DESCRIPTION OF THE DRAWINGS

FIG. 1 illustrates an example system embodiment;

FIG. 2 illustrates generally a high-performance compute environment;

FIG. 3 illustrates an exemplary storage input/output manager being used in a high-performance compute environment; and

FIG. 4 illustrates an example method embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The present disclosure addresses managing data I/O in a sophisticated compute environment such as high-performance computing (HPC) or an enterprise-class data center. A system, method and computer-readable media are disclosed which receive at a workload manager data associated with a job, and, based on the data, transmit a signal to instruct a storage input/output manager on how to manage a file transfer between the compute environment and the storage environment. Many scenarios could be applicable to the principles disclosed herein. For example, scenarios such as: (1) deferring execution of a job or process if the required I/O or transfer rate is not available, or in order for a transfer to complete such as a data stage in, (2) suspending, re-queuing or killing currently running jobs or processes to free up I/O or transfer capability for high priority workload, and (3) instructing the storage environment to asynchronously begin a data transfer (stage in) prior to placing the job or beginning a process, and then executing the job or process only when the transfer is complete.

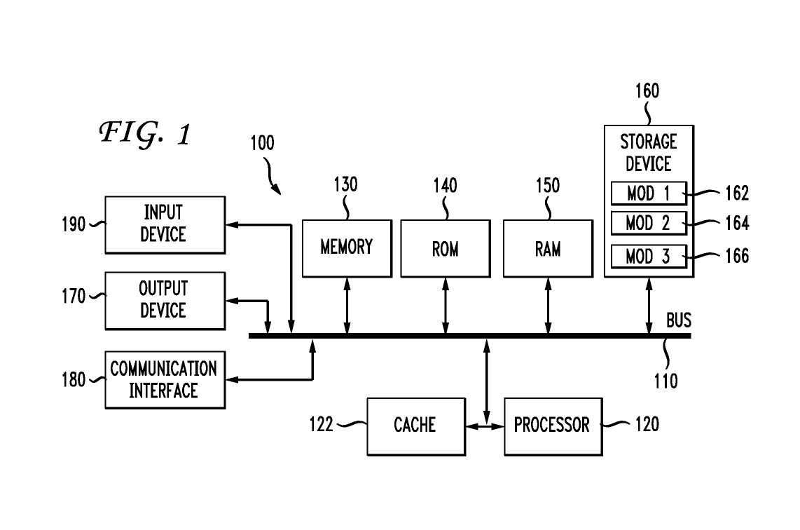

The workload manger may instruct the storage input/output manager to reserve storage space or throttle up or throttle down a data transfer between the compute environment and the storage environment. A brief introductory description of a basic general purpose system or computing device in FIG. 1 which can be employed to practice the concepts is disclosed herein. A more detailed description of managing file I/O in a compute environment will then follow.

These variations shall be described herein as the various embodiments are set forth. The disclosure now turns to FIG. 1.

With reference to FIG. 1, an exemplary system includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 150 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures, and may be a plurality of buses. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

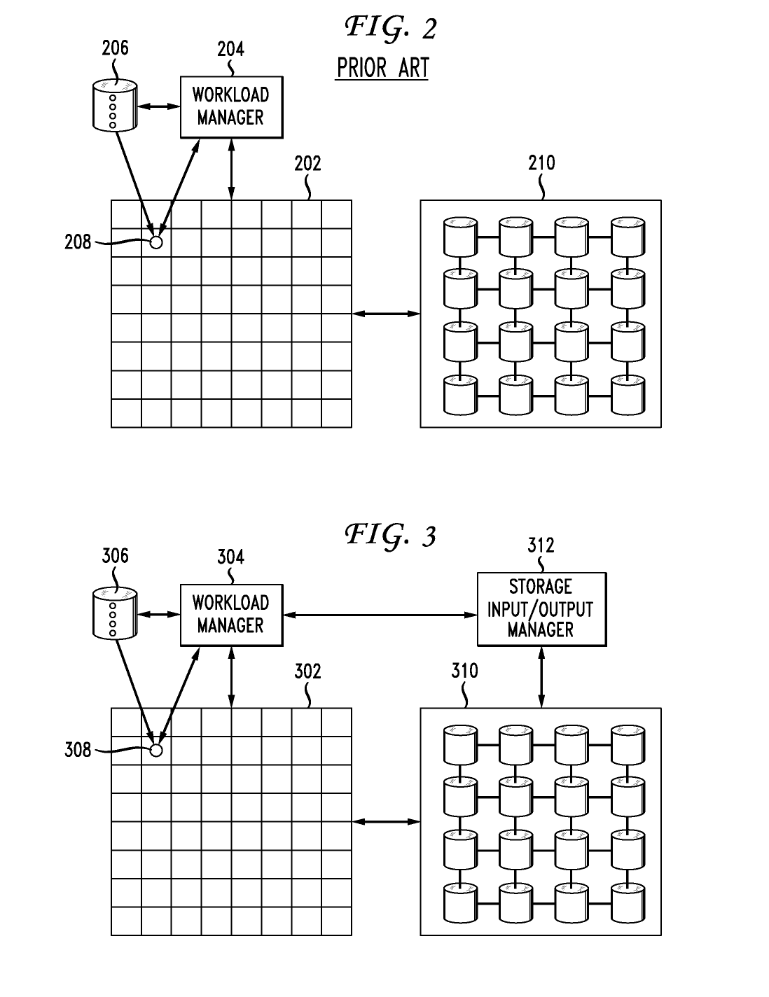

Having disclosed some components of a computing system, the disclosure now turns to FIG. 2, which illustrates generally a high-performance compute environment. The compute environment 202 consists of individual compute resources such as nodes, random access memories, and bandwidth. Although the compute environment 202 can normally include hard disk drives as its compute resources, in this disclosure the secondary storage devices such as hard disk drives are separately grouped as a storage environment 210. Each individual compute resource in the compute environment 202 can operate independently of each other or in concert with each other.

The workload manager 204 manages distribution of the jobs 206 in the compute environment 202. The workload manager 204 is able to access the information about each of the individual compute resources in the compute environment 202 and control many or all aspects of those resources. For instance, the workload manager 204 can turn on/off or throttle up/down individual compute resources in the compute environment 204, as well as monitor, organize, allocate, and prepare the compute resources. As a further illustration, the workload manager 204 may assign certain nodes and memories within the compute environment 202 to handle a specific computing job task (i.e., a task that is the job or a subpart of the job) at a certain level of performance during a set period of time, while concurrently assigning other nodes, memories, and bandwidth to handle other tasks. The workload manager 204 may give a job 208 reservations in time and space to perform tasks.

The workload manager 204 evaluates and deploys the jobs 206 to the compute environment 202. The jobs 206 may be deployed to the compute environment 202 in any number of ways. In one embodiment, the jobs may be placed in a queue before being deployed to the compute environment 202 one by one. In another embodiment, the workload manager 204 may dynamically rearrange the order in which the jobs get deployed according to the performance levels of individual compute resources within the compute environment 202. In yet another embodiment, the workload manager may schedule the jobs 206 to consume compute resources in the compute environment 202.

Once a job 208 is deployed by the workload manager 204 on to the compute environment 202, certain compute resources will be assigned to it or the job will use resources that have been reserved. When necessary, the workload manager 204 can migrate the job 208 from one set of compute resources to another set of resources within the compute environment 202. For example, if a node that can handle the job 208 more efficiently was previously unavailable but now becomes available, the workload manager 204 may reassign the job 208 to the newly available node in order to increase performance.

The storage environment 210 mainly consists of secondary storage devices. In other words, the storage devices in the storage environment 210 are largely non-volatile—that is to say the information stored inside the devices does not get lost even in the absence of electricity. Consequently, the storage devices in the storage environment 210 may retain their information for extended periods of time, if not permanently. Examples of secondary storage devices include hard disk drives, tape drives, optical discs such as CD-ROM, DVD-ROM, and Blu-ray discs, and solid-state drives (SSD). Compared to their volatile memory counterparts like random access memory (RAM), the secondary storage devices can manage only modest access speeds. Therefore, for most computational needs, the nodes in the compute environment 202 would typically be better off utilizing the faster primary storage devices such as cache memory or RAM. However, for more long-term storage needs such as storing large amounts of data in a database, the compute environment 202 would have to transfer data to and from the storage environment 210. In one embodiment, the data transfers occur in the form of a file input or output. In another embodiment, the data transfer may happen over a network such as a local area network, wide area network, and the Internet.

Within the storage environment 210, there can be a general file I/O system that is used for managing throughput and file I/O. For example, the workload manager 204 may reserve resources—10 nodes, for instance—for a job that is scheduled for 5 p.m. When the job 208 starts to run and if it needs a file loaded into memory or if it is going to output a data file for storage in the storage environment 210, the general file I/O system will manage the throughput and the file I/O for the data associated with the job 208.

The storage environment 210 may, as illustrated in FIG. 2, occupy a separate physical space apart from the rest of the compute environment 202, or as an alternative, the storage environment 210 may be part of the compute environment 202. The storage environment 210 may consist of arrays or clusters of individual storage elements such as hard disk drives, magnetic tape drives, optical discs, and solid-state memory. In one embodiment, the individual storage elements can be directly attached to the nodes in the compute environment 202. In another embodiment, the storage elements are grouped in a storage environment 210 and accessed by the rest of the compute environment 202 through a common interface.

FIG. 3 illustrates an exemplary storage input/output manager being used in a compute environment such as a high-performance compute environment. The discussions regarding the compute environment 302, the workload manager 304, the workload (a group of jobs in a queue) 306, the job 308, and the storage environment 310 are substantially similar to those regarding the compute environment 202, the workload manager 204, the jobs 206, the job 208, and the storage environment 210 illustrated in FIG. 2. In one embodiment, the storage input/output manager 312 oversees, controls, and monitors many aspects of the operation of the storage environment 310. The compute environment 302 may also communicate with the storage input/output manager 312 regarding the jobs 306 and any of the jobs that it is currently handling or will handle in the future.

The storage input/output manager receives instructions from the workload manager 304 regarding how to manage the various storage elements within the compute environment 310. In order to do this, the workload manager 304 first gathers information about the jobs 306 and the specific jobs 308, such as what kinds of storage resources—space, bandwidth, maximum/minimum throughput, etc.—are required to complete each job in the jobs 306, when the jobs need to be finished, each job's priority, service level agreement requirements for each job, etc. The workload manager 304 may also receive information from the storage input/output manager 312 regarding the individual storage elements in the storage environment 310 including the maximum/currently available storage capacity, throughput, access time, and power consumption for each storage element. To that end, the storage environment 310 may report to the workload manager 304 any information that might be helpful to the workload manager 304 in making intelligent decisions as to how to manage the various aspects of the storage environment 310. This information may include the list of file I/O instructions, currently available storage space, the current input/output performance levels of various storage elements, file system information, and any historical data. The information that the workload manager 304 receives from the various sources may pertain to usage history, current status, and/or anticipated future jobs of the compute environment 302 and the storage environment 310. The workload manager 304 can also receive information regarding service level agreements (SLA) from the jobs 306, the job 308, or the customers who have submitted the jobs 308.

Based on all the information collected, the workload manager 304 then intelligently determines how the resources in the storage environment 310 may be utilized for the jobs 306 and the jobs 308 in the compute environment and create instructions for the storage input/output manager 312 based on these decisions. For example, in one embodiment a particular job 308 may have a service level agreement associated with it, in which it has very high priority over the use of resources and needs to be able to complete the job 308 within 10 minutes of the workload manager receiving the job 308 submitted by the user. As part of the fulfillment of the service level agreement, the user submitting the job 308 has a privilege level that permits the user to specify a guaranteed quantity of file I/O, which the workload manager 304, receives with the job request and therefore reserves file I/O bandwidth resources as well as provides an instruction to the storage input/output manager 312 to throttle up the transfer of data from a long-term storage device into RAM for processing at the requested file I/O bandwidth rate. In this scenario, absent such instruction, it might take 45 minutes for the file I/O to proceed on a normal assigned and managed basis, which would violate the service level agreement with the user. However, given the extra instruction from the workload manager 304, the file I/O may only take five minutes, thus enabling the job to complete quicker because the necessary data will be loaded from a hard drive into RAM ahead of data requested by other jobs, and thus be in position for use more quickly by any processing step that is associated with the job. In another embodiment, a file I/O instruction from the workload manager 304 to the storage input/output manager 312 is based on the knowledge of the overall compute environment 302 as well as the knowledge of the overall storage environment 310 and the storage input/output manager 312, where the storage input/output manager 312 knows all of the other file I/O instructions that it has received. For example, the workload manager 304 may know that it cannot instruct more than half of its jobs to do throttled-up file transfers between the hours of 12 p.m. and 3 p.m. because the storage environment 310 would not be able to handle the requirements during those hours.

In another example, assume the storage input/output manager reports to the workload manager 304 that all the jobs with guaranteed file I/O are not receiving their guaranteed amount of I/O. The workload manager 304 could then follow a policy that would address the situation in one or more different ways. For example, the policy could be to drop the guaranteed I/O bandwidth for enough of the lowest priority jobs among the high-priority jobs with guaranteed I/O bandwidth until the remaining high-priority jobs have their I/O bandwidth guarantees met, as reported by the storage input/output manager. The implemented policy could be simply to drop the guaranteed I/O bandwidth of each high-priority job with I/O bandwidth guarantees across the board in steps until the reduced guarantees are met as reported by the storage input/output manager. In another example, the system administrator could manually determine the policy for a job, groups of jobs, particular people submitting jobs, and so forth.

In yet another example, a particular job may require an input data file of considerable size. Based on information received from the storage environment regarding currently available transfer rate or an ETA of transfer (if available), the system may defer the job until such time that the transfer is complete and the data file is available. If the job is of sufficiently high priority, the workload manager may choose to suspend, re-queue or kill currently running jobs to allow the transfer rate to increase so that the job can be serviced as soon as possible

In one embodiment, the workload manager 304 may map out the I/O schedule in advance for each storage element in the storage environment 310 in terms of how each data transfer to and from those storage elements will be throttled up, throttled down, paused, resumed, given priority, etc. In another embodiment, the workload manager 304 may use conditional statements in such schedules so that the conditions can be determined at a later time. For example, the workload manager 304 can schedule for a certain file transfer for a particular job to commence at 3:35 a.m. if a previous job is at least 70% accomplished by that time, or if the progress rate for the previous job is less than 70%, then commence the new file transfer at only 20% of its peak file I/O performance.

Next, the workload manager 304 sends these instructions to the storage input/output manager 312 through a signal. Based on the instructions, the storage input/output manager 312 would manage the storage elements within the storage environment 210 and the data transfers that occur between the compute environment 302 and the storage environment 310. As the workload manager 304 continues to monitor the statuses of the jobs 306, the job 308, the compute environment 302, and the storage environment 310, the workload manager 304 constantly updates its previously issued instructions or issues new commands to the storage input/output manager 312. In one embodiment, the storage input/output manager 312 influences and/or controls the general file I/O system within the storage environment 310, the general file I/O system being used for managing throughput and file I/O instructions. In another embodiment, the general file I/O system is integrated into the storage input/output manager 312, and the storage input/output manager directly controls the throughput and the file I/O instructions within the storage environment 310.

The storage input/output manager 312 may manage the storage environment 310 and any file input/output between the compute environment 302 and the storage environment 310 in a number of ways. In one embodiment, the storage input/output manager 312 may, per instructions from the workload manager 304, throttle up or throttle down a particular file transfer operation that was started by a particular job 308 running in the compute environment 302 in order to, for example, achieve the performance level guaranteed by a service level agreement.

In another embodiment, the workload manager 304, through its instructions, negotiates with the storage input/output manager 312 for a storage resource within the storage environment 310. The storage resource can be storage space, storage input/output performance, or any other limited resource within the storage environment 310 that may be consumed by a compute job 308. For example, a job 308 may call for the minimum of 2 terabytes and the maximum of 5 terabytes of space in the storage environment 310 to back up some data. In another example, the job 308 may require a sustained random read/write performance of at least 200 input/output operations per second (IOPS) for the next 75 minutes for its database maintenance work. The negotiation for a storage resource can be more specific. For instance, the job 308 may require the use of some specific storage elements within the storage environment 310, such as a specific set of hard disk drives or SSDs. The negotiation can be more general as well. For example, the workload manager 304 may negotiate for any available resources within the storage environment 312 as long as the job 308 gets done by a certain set time limit.

Should a negotiation for storage resources fall through, the workload manager 304 may take one or more of the following actions: (1) suspend the job, for which the storage resources were to be used, until the resources become available, (2) terminate the job, or (3) explore other options through the storage input/output manager. The method may also include suspending, re-queuing or killing a currently running (and perhaps lower priority) job or process to free up storage resources. One of more of these steps can occur if no negotiated storage resource exists. With regards to the first option, the workload manager 304 may choose to suspend the blocked job and instead execute file operations for a different job first. As more storage resources become available, the workload manager 304 can reassign jobs to the resources according to their needs and priorities. With regards to the second option, a policy may dictate that the blocked job be terminated if the required storage resources cannot be arranged. The terminated job may then be taken off the compute environment 202 until it gets redeployed. With the third option, in one embodiment, the storage input/output manager 312 may suggest to the workload manager 304 a potentially suitable alternative storage resource, in which case the workload manager 304 would weigh the benefits and drawbacks of taking the alternative approach and make a decision based on artificial intelligence and/or customer feedback and/or pre-configured policies. For instance, instead of the 500 Mbps throughput that the workload manager 304 was negotiating for, for a certain job, it may settle for a set of storage resources that can guarantee only 480 Mbps based on the 10% margin of tolerance that the customer has preauthorized. In another embodiment, the workload manager 304 may raise the priority level of the job 308 in order to gain access to the required storage resources within the storage environment 310.

In another embodiment, even after successfully negotiating for a storage resource within the storage environment 310, the workload manager 304 can renegotiate for modification of the terms of the storage resource. While the workload manager 304 continuously monitors the statuses of the compute environment 302, the storage environment 310, the jobs 306, and the job 308 deployed in the compute environment 308, the workload manager 304 may have to dynamically allocate and reallocate jobs and various resources. In doing this, some of the storage resources may also have to be reassigned, reallocated, or readjusted. In one embodiment, the steps taken for renegotiating for modification of the terms of the storage resource are substantially similar to those needed for negotiating for a storage resource for the first time. In other words, the workload manager 304 offers a set of parameters for a job 308 to the storage input/output manager 312, and the storage manager 312 may either accept or reject the terms. If rejected, the workload manager 304 may suspend the job, terminate the job, or explore other options.

In one embodiment, the workload manager 304 may have different user accounts set up for its customers and allow the customers to deposit a resource credit into their individual accounts. Depending on how much compute resource or storage resource is dedicated to the jobs that a user has submitted, the amount in the user account may be deducted accordingly. As an illustration, according to a predetermined fee schedule, users may be charged different amounts of money depending on how much storage resource was used to process their jobs. If a user opts to expedite the process of one of her jobs by using extra bandwidth for data transfers between the compute environment 302 and the storage environment 310, she would be charged extra for such use. On the other hand, she may choose to lower some of the performance levels guaranteed in her service level agreement for some of her less urgent jobs so that those jobs would consume fewer resources and thus lower the cost for her.

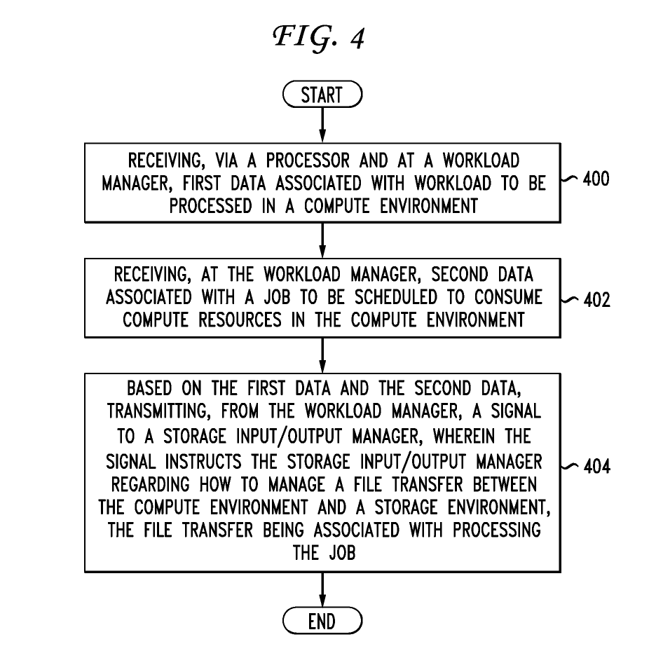

Having disclosed some basic system components and concepts, the disclosure now turns to the exemplary method embodiment shown in FIG. 4. For the sake of clarity, the method is described in terms of an exemplary system 100 as shown in FIG. 1 configured to practice the method. The steps outlined herein are exemplary and can be implemented in any combination thereof, including combinations that exclude, add, or modify certain steps.

The system 100 receives first data associated with jobs to be processed in a compute environment (400). In one embodiment, the system 100 can be a workload manager that evaluates and deploys jobs in the jobs into the compute environment. In another embodiment, the first data is associated with the job that is currently being processed in the compute environment. The first data may also include information regarding when the data transfers are needed within the jobs as well as what the various SLA requirements are for the jobs. Next, the system 100 receives second data associated with a job to be scheduled to consume compute resources in the compute environment (402). In one embodiment, the second data is associated with a job that is currently consuming compute resources in the compute environment. The job may have been part of the queue of jobs before being deployed in the compute environment by the workload manager. The job may have been submitted by a customer. For example, a customer can submit to the workload manager a job related to processing 200,000 entries of census data. The job can be placed in a queue as part of the larger group of jobs that the workload manager is currently managing. In time, the workload manager deploys the census job in the compute environment and assigns appropriate compute resources, such as a group of nodes, memory, and bandwidth, to handle the job. The second data may include information regarding when the data transfers may be needed and what the SLA requirements are for the job.

The system 100 then transmits a signal, based on the first data and the second data, to a storage input/output manager, wherein the signal instructs the storage input/output manager regarding how to manage a data transfer between the compute environment and a storage environment, the data transfer being associated with processing the job (404). In one embodiment, the instructional signal may be further based on the information that the workload manager receives from the storage input/output manager with regards to the storage environment's past, current, and future data transfers and storage resources. The data transfer can be a file input or output. The data transfer may occur over a system bus, a local area network, a wide area network, or the Internet. The data transfer may also occur wirelessly. In one embodiment, the workload manager and the storage input/output manager exist in two physically separate locations. In another embodiment, the two managers may be housed in the same location. The workload manager may instruct the storage input/output manager regarding how to manage data transfers by instructing the storage input/output manager to initiate, terminate, throttle up, throttle down, pause, or resume data transfers.

The workload manger may also instruct the storage input/output manager by negotiating for a storage resource such as storage space, storage data input/output performance, etc. For example, the workload manager can ask if it can reserve 900 gigabytes of storage space spanning over the five specified storage devices and sustain reading and writing operations during the hours of 1 a.m.-4 a.m. at the minimum of 200 IOPS and 600 MB/s. The negotiated terms of use can be changed later as the workload manager renegotiates the terms or cancels the job. In one embodiment, the workload manager may send a signal to the storage input/output manager regarding how to manage a file transfer associated with a job currently being processed in the compute environment.

In another embodiment, the signal may instruct the storage input/output manager regarding how to manage a file transfer associated with a job scheduled to be deployed into the compute environment in the future. For example, a job may have resources such as nodes reserved at 4 p.m. and the instruction from the workload manager may instruct the storage input/output manager that there may be some processing that needs to occur before the data transfers. Thus, the instruction to the storage input/output manager may hold the file I/O for 20 minutes while some other processing occurs, and then throttle up the file I/O for the next 10 minutes to quickly load the data into RAM.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, Flash memory, solid-state disk (SSD), CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of general-purpose or special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, massively parallel processing systems, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein are described in the context of high-performance computing (HPC) equipment. However, these principles can be applied in a non-HPC environment as well, such as an enterprise-class data center, multi-processor service environment such or a mainframe. The compute environment 302, for instance, may contain only a few nodes or even a single node. By the same token, the storage environment 310 may contain only a handful of storage elements or even a single storage device. The storage input/output manager 312 may operate as the exclusive gateway for all the file I/O requests from the compute environment 302 to go through, or it may merely work as a complementary channel, through which some but not all data I/O requests may go, allowing other I/O requests to reach the individual storage elements within the storage environment 310 directly from the nodes in the compute environment 302. The data transfers between the compute environment 302 and the storage environment 310 may also be routed through one or both of the workload manager 304 and the storage input/output manager 312, rather than occurring through a direct link established between the compute environment 302 and the storage environment 310. Various modifications and changes may be made to the principles described herein without following the example embodiments and applications illustrated and described herein, and without departing from the spirit and scope of the disclosure.

We claim:

1. A method comprising:
receiving, via a processor and at a workload manager, first data associated with jobs to be processed in a compute environment;
receiving, at the workload manager, second data associated with a job to be scheduled to consume compute resources in the compute environment; and
based on the first data and the second data, transmitting, from the workload manager, a signal to a storage input/output manager, wherein the signal instructs the storage input/output manager regarding how to manage a data transfer between the compute environment and a storage environment, the data transfer being associated with processing the job.

2. The method of claim 1, wherein the workload manager evaluates and deploys the jobs into the compute environment.

3. The method of claim 1, wherein the signal instructs the storage input/output manager to manage the data transfer by one of initiating the data transfer, terminating the data transfer, throttling up the data transfer, throttling down the data transfer, pausing the data transfer, and resuming the data transfer.

4. The method of claim 1, wherein the signal instructs the storage input/output manager to manage the data transfer by negotiating for a storage resource within the storage environment.

5. The method of claim 4, wherein the storage resource is at least one of storage space and storage input/output performance.

6. The method of claim 4, the method further comprising:
if the signal instructing the storage input/output manager to manage the data transfer by negotiating for a storage resource fails to yield a negotiated storage resource, performing at least one of:
suspending the job until the storage resource becomes available;
suspending, re-queuing or killing a currently running, lower priority, job;
terminating the job; and
receiving information about a potentially suitable storage resource that can be guaranteed.

7. The method of claim 4, wherein the signal instructs the storage input/output manager to manage the data transfer by renegotiating for modification of terms of the storage resource.

8. The method of claim 1, the method further comprising:
receiving, from the storage input/output manager, third data associated with the storage environment, the third data being associated with at least one of current storage space, current storage input/output performance, historical storage space, and historical input/output performance of the storage environment; and
transmitting the signal to the storage input/output manager further based on the third data.

9. The method of claim 1, further comprising depositing a resource credit into a user account associated with a user who submitted the job, wherein the user account may be charged according to usage of the resource environment.

10. A system comprising:
a processor; and
a computer-readable storage device storing instructions which, when executed by the processor, cause the processor to perform a method comprising:
receiving, at a workload manager, first data associated with jobs to be processed in a compute environment;
receiving, at the workload manager, second data associated with a job to be scheduled to consume compute resources in the compute environment; and
based on the first data and the second data, transmitting, from the workload manager, a signal to a storage input/output manager, wherein the signal instructs the storage input/output manager regarding how to manage a data transfer between the compute environment and a storage environment, the data transfer being associated with processing the job.

11. The system of claim 10, wherein the signal instructs the storage input/output manager to manage the data transfer by one of initiating the data transfer, terminating the data transfer, throttling up the data transfer, throttling down the data transfer, pausing the data transfer, and resuming the data transfer.

12. The system of claim 10, wherein the signal instructs the storage input/output manager to manage the data transfer by negotiating for a storage resource within the storage environment, wherein the storage resource is at least one of storage space and storage input/output performance.

13. The system of claim 12, wherein the computer-readable storage device stores additional instructions which, when executed by the processor, cause the processor to perform the method further comprising:
if the signal instructing the storage input/output manager to manage the data transfer by negotiating for a storage resource fails to yield a negotiated storage resource, performing at least one of:
suspending the job until the storage resource becomes available;
suspending, re-queuing or killing a currently running, lower priority, job;
terminating the job; and
receiving information about a potentially suitable storage resource that can be guaranteed.

14. The method of claim 12, wherein the signal instructs the storage input/output manager to manage the data transfer by renegotiating for modification of terms of the storage resource.

15. A computer-readable storage device storing instructions which, when executed by a processor, cause the processor to perform a method comprising:
receiving, at a workload manager, first data associated with jobs to be processed in a compute environment;
receiving, at the workload manager, second data associated with a job to be scheduled to consume compute resources in the compute environment; and
based on the first data and the second data, transmitting, from the workload manager, a signal to a storage input/output manager, wherein the signal instructs the storage input/output manager regarding how to manage a data transfer between the compute environment and a storage environment, the data transfer being associated with processing the job.

16. The computer-readable storage device of claim 15, wherein the workload manager evaluates and deploys the jobs into the compute environment.

17. The computer-readable storage device of claim 15, wherein the signal instructs the storage input/output manager to manage the data transfer by one of initiating the data transfer, terminating the data transfer, throttling up the data transfer, throttling down the data transfer, pausing the data transfer, and resuming the data transfer.

18. The computer-readable storage device of claim 15, wherein the signal instructs the storage input/output manager to manage the data transfer by negotiating for a storage resource within the storage environment, wherein the storage resource is at least one of storage space and storage input/output performance.

19. The computer-readable storage device of claim 15, wherein the instructions, when executed by the processor, cause the processor to perform the method further comprising:
receiving, from the storage input/output manager, third data associated with at least one of current storage space, current storage input/output performance, historical storage space, and historical input/output performance of the storage environment; and
transmitting the signal to the storage input/output manager further based on the third data.

20. The computer-readable storage device of claim 15, wherein the instructions, when executed by the processor, cause the processor to perform the method further comprising:
depositing a resource credit into a user account associated with a user who submitted the job, wherein the user account may be charged according to usage of the resource environment.
